(19) United States
(12) Patent Application Publication
(10) Pub. No.: US 2004/0080780 A1
(43) Pub. Date: Apr. 29, 2004

(54) Electronic media production system and method

(76) Inventor: Paul John Fallon, London (GB)

Correspondence Address: BAKER & HOSTETLER LLP, Suite 1100, Washington Square, 1050 Connecticut Avenue, N.W., WASHINGTON, DC, 20036, US

(21) Appl. No.: 10/277,976

(22) Filed: Oct. 23, 2002

(51) Int. Cl. G06F 15/00; G06F 13/00; G06F 3/12

(52) U.S. Cl. 358/1.15; 358/1.18

(57) ABSTRACT

An electronic media production system produces an electronic media product which comprises electronic media and packaging for the electronic media. Electronic media data and associated electronic media packaging data for a plurality of electronic media products are stored at a data source. A user requests an electronic media product from the data source and electronic media data and associated electronic media packaging data for the electronic media product are downloaded to the user's computer for the production of the electronic media product by writing the electronic media data to an electronic media and the printing of packaging for the electronic media using the electronic media packaging data. Thus, a complete packaged electronic media product is produced simply from downloaded data from a remote data source.

The present invention relates to an electronic media production apparatus and method in which electronic media products which comprise electronic media and packaging for the electronic media can be produced.

Traditionally, electronic media products were purchased by purchasing electronic media in packaging from a vendor such as a high street shop, or by mail order delivery. With the advent of the Internet, it has become more common for electronic media products to be obtained or purchased by downloading electronic media data over the Internet. The electronic media data can be purchased or can be obtained free of charge.

The disadvantage of downloading electronic media data is that the product obtained differs from the product which can be purchased in the traditional manner by purchasing a physical copy of the electronic media in its packaging. The purchasers of such downloaded electronic media data do not benefit from the packaging of the product which can contain useful information as well as enhancing the aesthetic appearance of the product. Thus, even if a purchaser of the electronic media data creates a physical copy on an electronic media, the product lacks the official packaging.

It is an object of the present invention to overcome this deficiency in the prior art. The present invention provides a system and method in which an electronic media product which comprises an electronic media and packaging for the electronic media can be produced by a customer from downloaded code from a supplier. A user is able to download electronic media data and associated electronic media packaging data over a communications network, The electronic media data is written to an electronic media to produce a physical copy. The electronic media packaging data is sent to a printer to print packaging for the electronic media. Thus in this way a user is able to put the packaging together with the electronic media in order to produce a conventional electronic media product.

In accordance with the present invention, the electronic media can comprise any known conventional media such as a CD, a DVD, a midi disc, an analogue tape cassette device or a solid state memory device. The type of content of the electronic media can comprise any type of electronic media such as audio, e.g. music or stories, video, images, computer data such as computer files, or computer programs. The packaging associated with the electronic media can comprise anything provided ancillary to the electronic media such as the electronic media label, the packaging or box encasing the electronic media, the CD, DVD or midi disc sleeve, booklets or pamphlets, and manuals.

Thus, in accordance with the present invention, a user is able to obtain a physical copy of an electronic media product complete with packaging as if they had purchased the product from a conventional retail outlet. This is thus an efficient way of providing a full product in the same aesthetic condition as if the product bad been bought from a traditional retail outlet. For the supplier or retailer, the system is highly efficient since there is no need to provide for production, storage and shipping of the physical product. For the receiver or customer, the system is convenient for obtaining the product since there is no need to visit a retail outlet or suffer a delivery delay for delivery of a physical product. The receiver or purchaser need only provide a blank electronic media such as a blank CD, DVD, mini disc or analogue tape so that the electronic media data can be written onto it. Since such blank media are readily available at low cost, this does not present a significant obstacle or deterrent to the receiver or purchaser. Indeed, the need to supply a blank electronic media is for more preferable to having to inconveniently purchase a physical electronic media product in the traditional way.

In one embodiment of the present invention, an application running on a user's computer controls the writing of the electronic media and the printing of the packaging so as to automatically produce an electronic media product for each set of electronic media data and associated electronic media packaging data downloaded.

In one embodiment the users computer can be programmed to automatically produce the electronic media whenever the required electronic media data and associated electronic media packaging data is downloaded for the electronic media. Alternatively, in order to allow batch downloading of data for electronic media, the user's computer can allow a user to allow a user to select to produce the electronic media by identifying electronic media for which data has been downloaded. Thus, this alternative embodiment allows a user to download data for multiple electronic media products and to then select to produce the electronic media one at a time. This enables the user to make the blank media available, e.g. by inserting blank CDs, DVDs, mini discs or analogue tapes into the writing device one at a time as required. In this embodiment, in order to prevent multiple copies being made when not allowed, once data has been written to the electronic media and printed, the data is deleted from a user's computer to prevent further copies being made of the electronic media product. As an alternative to deleting files, they can be suitably disabled.

In one embodiment of the present invention, a user's computer includes an application for controlling the media writing device and the printer in order to produce the electronic media product. In an alternative embodiment, the application on the user's computer is arranged to interface to a writing application for writing electronic media, and a printing application for controlling the printer to print the packaging.

In one embodiment of the present invention, the system can be implemented over a communications network using web pages. The source of electronic media products can comprise a website accessible using the browser over the communications network. In one embodiment, the application running on the user's computer interfaces to a conventional web browser such as Microsoft Internet Explorer (Trade Mark) or Netscape (Trade Mark). In an alternative embodiment, the application includes its own web browsing functionality to directly communication with the web server.

In one embodiment, in order to configure a user's computer for production of electronic media, computer code is loaded onto the user's computer. The computer code, when loaded on the user's computer, comprises the application for controlling the production of the electronic media product. A computer code can be provided to the user's computer using any conventional form of carrier medium. The carrier medium can comprise a storage medium such as a floppy disk, hard disk, CD-ROM, or programmable storage device. Alternatively, the carrier medium can comprise a transient medium such as a signal, e.g. an electrical, optical, microwave, radio frequency or optical signal. One such form of signal comprises a TCP/IP signal carrying computer code over a communications network such as the Internet.

In one embodiment of the present invention where multiple users can access the source of data for the electronic media, the configuration of the user's computer can vary. For example, the user's computer may have no ability to burn mini discs. Thus, in this embodiment of the present invention the source of data can store a plurality of different versions of code for downloading to the users' computers. Each version is suitable for a particular configuration of a user's computer. The configuration of the user's computer can be determined and based on this determination the version of the code to be downloaded to the user's can be determined.

In one embodiment of the present invention it is possible to download an updated version of the code at the user's computer if there is a later version available. In this embodiment the source of data identifies the version loaded at the user's computer and compares this with the stored versions of the code to determine whether a later version is available. If so, this can be downloaded to the user's computer.

One aspect of the present invention provides an electronic media production system for enabling a remote apparatus to produce at least one electronic media product in which electronic media data and associated electronic media packaging data for a plurality of electronic media products is stored. The electronic media data and associated electronic media packaging data are downloaded on request to a user's computer. A personalization interface is provided to allow personalization of the content of the electronic media data and/or the electronic media packaging data before download.

Thus, in accordance with this aspect of the present invention, a user is able to select to personalize the electronic media data and/or the electronic media packaging data. Thus for example, for the downloading of an audio CD content, a user can select the order of tracks on the CD. In this way the electronic media data is personalized. Alternatively, a user can select to personalize the packaging. For example, there may be alternative packaging available and a user can select one of the alternatives. Also, a user may be able to select from alternative combinations of design. Further, a user may be able to enter personal information such as their name onto the packaging, e.g. the CD sleeve or label, to personalize the packaging in this way. The personalization of the content of the electronic media and the packaging can either be carried out manually by selection or by input of data by a user, or automatically at the data source using already known personalization information for the user, e.g. name, age, sex, etc.

In the present invention, a user can use any type of processing device capable of producing an electronic media product. Thus, also the term “a user's computer” is used hereinabove, the present invention encompasses any apparatus capable of producing the electronic media product and connection to a communications network.

Embodiments of the present invention will now be described with reference to the accompanying drawings, in which:

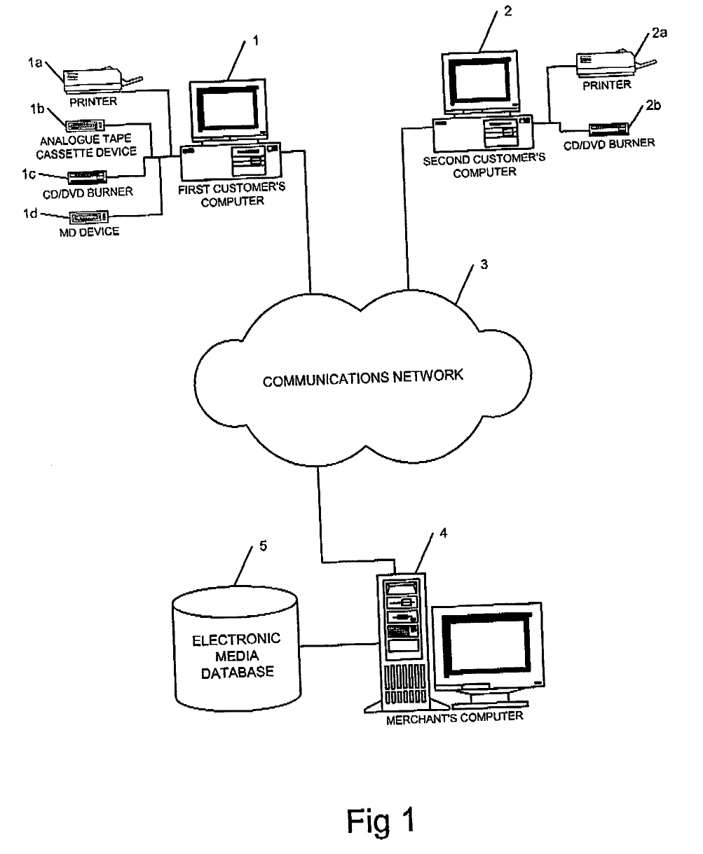

FIG. 1 is a schematic diagram of an electronic media production system in accordance with an embodiment of the present invention;

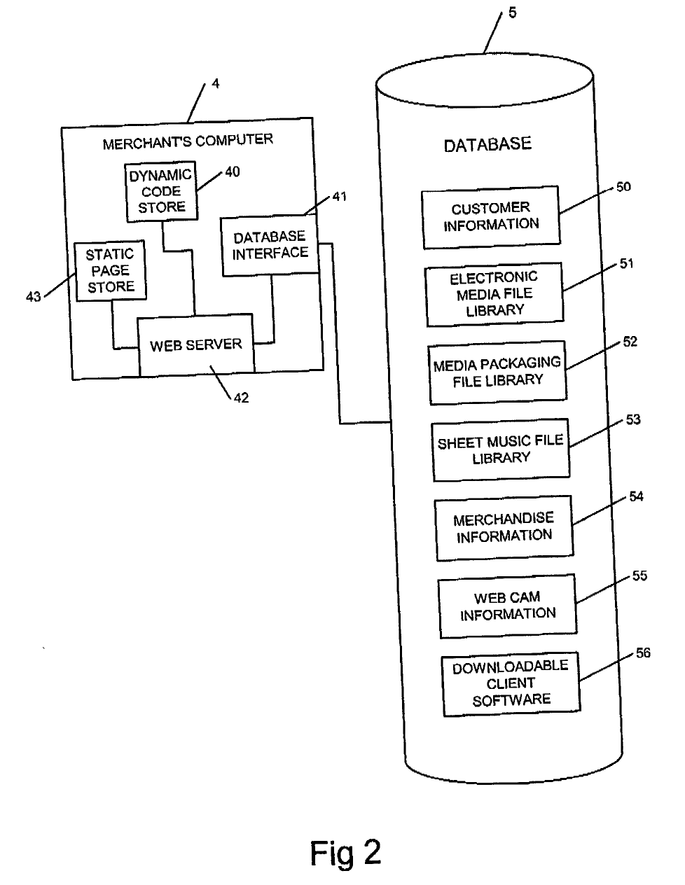

FIG. 2 is a schematic diagram of the merchant's computer system in the embodiment of FIG. 1;

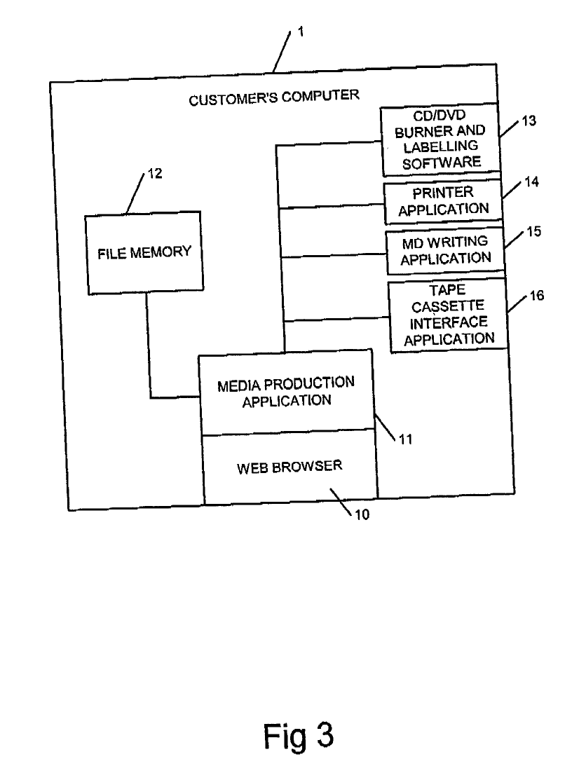

FIG. 3 is a schematic diagram of the customer's computer in accordance with one embodiment;

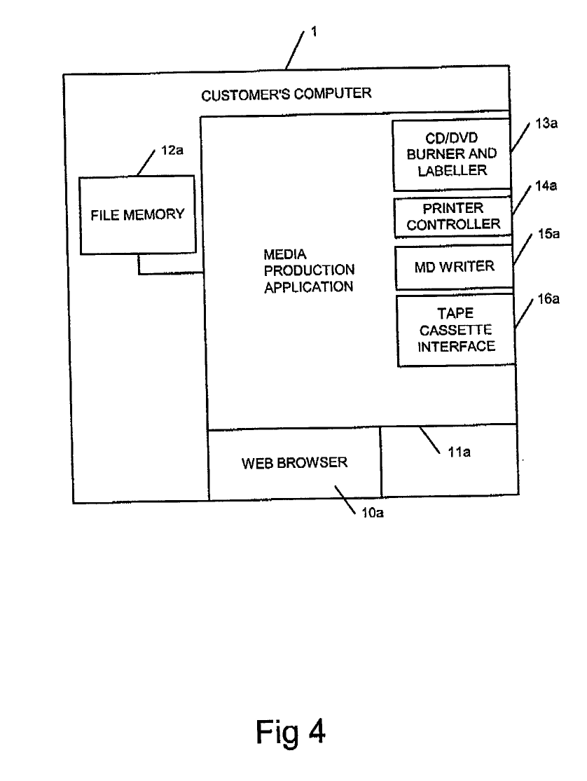

FIG. 4 is a schematic diagram of the customer's computer in accordance with another embodiment;

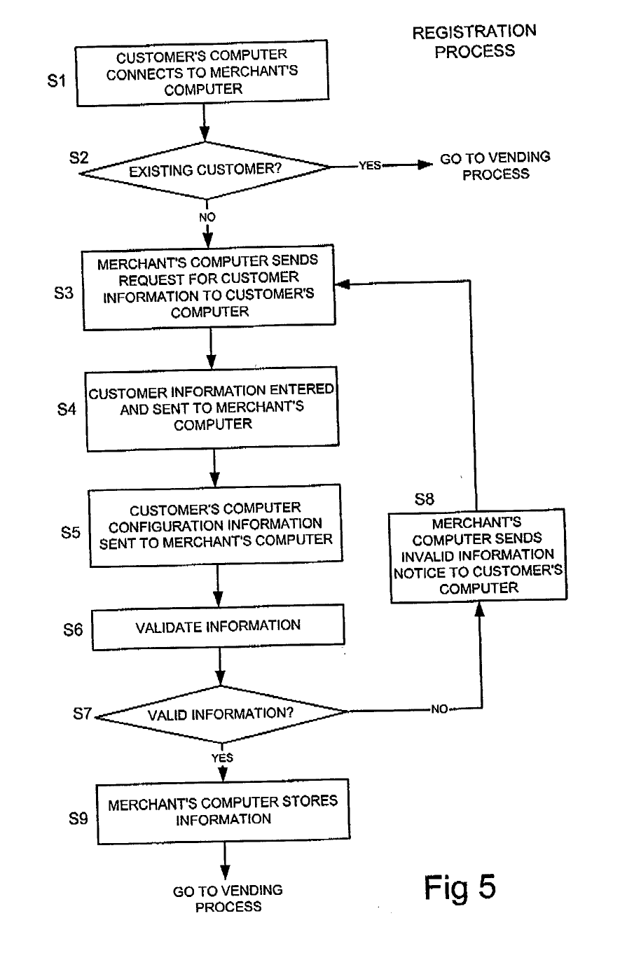

FIG. 5 is a flow diagram illustrating the registration process in accordance with one embodiment of the present invention; and

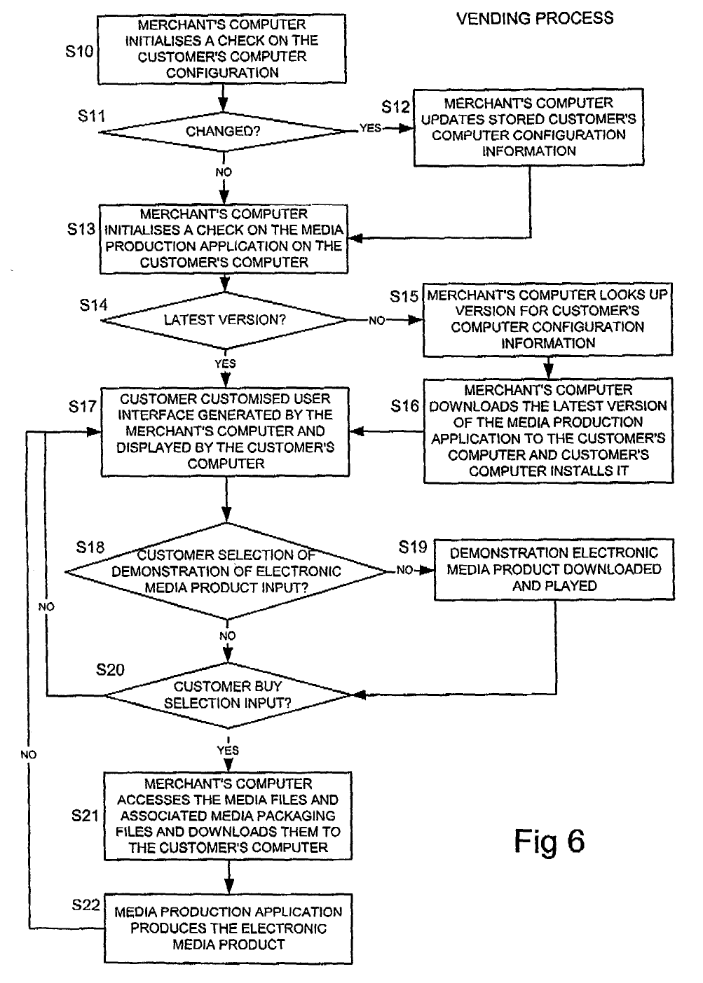

FIG. 6 is a schematic diagram illustrating the vending processing in accordance with an embodiment of the present invention.

Referring to FIG. 1, an electronic media production system comprises a merchant's computer 4 provided with an electronic media database 5 and connected to a communications network 3 such as the Internet. Also connected to the communications network 3 are a first customer's computer 1 and a second customer's computer 2. The first customer's computer is provided with a printer 1a, an analogue tape cassette device 1b, a CD/)VD burner 1c and a mini disc device 1d. Thus the first customer's computer 1 is capable of producing electronic media products in the form of analogue tapes, CDs, DVDs and mini discs. The second customer's computer 2 is provided with a printer 2a and a CD/DVD burner 2b. Thus, the second customer's computer is capable of providing electronic media products in the form of CDs and DVDs only.

In the present embodiment the connections made between the first customer's computer 1, the second customer's computer 2 and the merchant's computer 4, are using the HTTP protocol to provide the customers with web interfaces.

FIG. 2 is a schematic diagram of the merchant's computer and the electronic media database 5. The merchants computer 4 is provided with a web server 42 to serve web pages over the communications network 3 to the customers' computers 1 and 2. The web server 42 is provided with static pages (i.e. HTML code) in the static page store 43. Also, the web server is able to generate dynamic web pages using code stored in the dynamic web store 40. Such dynamic web pages can, for example, be Active Server pages (Trade Mark). A database interface 41 is provided to interface the web server to the electronic media database 5.

Within the electronic media database 5, there is stored customer information 50. The customer information includes all the information necessary for identifying the customer and for keeping transaction records. For example, the customer information 50 can include a username and password, a user's full name and address, other personal information, the IP address of the customer's computer, information on the hardware and software configuration of the customer's computer, secure payment details such as credit card number, and customer purchase records.

The electronic media data 5 also contains the electronic media file library 51. The electronic media file library contains the electronic media data which is downloadable to be written onto the electronic media at the customer's computer. Thus, the electronic media files can comprise audio files, video files, data files such as pictures or other data, and computer program files. The files can be stored in a hierarchical arrangement so that a set of data files which comprise a product can be arranged hierarchically under a product name. This hierarchical arrangement of individual units within a product enable a user to personalize a product by rearranging the order in which the units of a product are stored in the final produced electronic media product.

The electronic media database 5 also contains a media packaging file library 52. The media packaging file library contains files associated to the electronic media files for the production of packaging for the electronic media. The files can comprise text or image files for boxes, covers, sleeves, booklets, manuals, or any other pieces of literature or packaging to accompanying the electronic media in the final electronic media product. The media packaging files are arranged in the database 5 to be associated with the corresponding electronic media files.

The electronic media database 5 also includes a sheet music file library 53. This library contains files of sheet music associated with electronic media. This can be considered to be a special case of the media packaging for an electronic media file. For some electronic media products such as CDs or videos, part of the product can include sheet music.

The electronic media database 5 also contains merchandise information 54. Merchandise information contains information related to the electronic media product such as t-shirts, concert tickets, posters, etc. This information is used to provide information on associated merchandise to electronic media products when a customer accesses the merchant's computer in order to purchase an electronic media product. Merchandise information can be displayed to encourage the purchase of associated merchandise.

The electronic media database 5 also contains web cam information 55. The web cam information includes information on web cams available to provide live web cam video displays of sites such as studios associated with the electronic media products. Thus, when a customer wishes to purchase an electronic media product they can be presented with the option of accessing web cam images associated with the electronic media products. The web cam information 55 can store not just the information presented to the customer, but also the information used by the merchant's computer 5 in order to redirect the web browser of the customer's computer to the web cam site.

The electronic media database 5 also contains the downloaded client software 56 in order to enable the customer's computer to download the data for the electronic media products and to produce the electronic media products automatically without requiring the intervention of the user to write electronic media and print packaging. The code stored in the downloadable client software storage 56 comprises a plurality of versions of software suitable for different customers' computers. For example, the first customer's computer 1 is able to generate electronic media products as analogue tapes, CDs, DVDs or mini discs. Thus, the first customer's computer 1 requires software to provide this functionality. The second customer's computer 2 only has the capability of producing CDs or DVDs and thus software of a different level of functionality is required.

FIG. 3 is a schematic diagram of the customer's computer 1 in accordance with one embodiment of the present invention.

In this embodiment of the present invention, a conventional web browser 10 such as Microsoft Internet Explorer (Trade Mark) or Netscape (Trade Mark) is loaded onto the customer's computer and a media production application 11 is loaded as an add-on to the web browser 10. The media production application 11 comprises the downloadable client software which is downloadable from the electronic media database 5 at the merchant's computer 4. The media production application works closely with the web browser 10 as an add-on as is well-known in the prior art. A file memory 12 is provided for temporary storage of the downloaded electronic media data and electronic media packaging data. The customer's computer is also provided with conventional proprietary CD/DVD burning and labelling software. Further, the customer's computer 1 is provided with a printer application 14 which can comprise any suitable document processing application such as Adobe Acrobat for PDF documents or Microsoft Word for text documents in order to control the printer to print the packaging. The customer's computer 1 is also provided with a mini disc writing application 15 for controlling the mini disc device 1d to write the electronic media data to a blank mini disc. The customer's computer 1 is further provided with a tape cassette interface application for controlling a conventional analogue tape device 1b in order to write the electronic media data to a blank tape cassette in the analogue tape cassette device 1b.

Thus, in accordance with this embodiment of the present invention, the downloadable media production application 11 interfaces closely with a conventional web browser 10 and with conventional proprietary software for generating the electronic media and the packaging automatically. In this embodiment, because of the multiple possible types of proprietary software to which the media production application 11 may need to interface, the media production application 11 can be provided specifically for the software configuration on the customer's computer 1. Thus, within the downloadable client software 56 in the database 5, there can be a version available for a number of different hardware and software configurations for the customer's computer 1.

FIG. 4 illustrates an alternative embodiment of the present invention in which the media production application 11a interfaces closely to a web browser 10a and stores the electronic media data and the electronic media packaging data in a file memory 12a. In this embodiment the media production application is provided with its own CD/DVD burner and labeller 13a, printer controller 14a, mini disc writer 15a and tape cassette interface 16a. Thus, in this embodiment of the present invention, less reliance is placed on the capability of other applications within the customer's computer 1.

Although not shown in FIGS. 3 and 4, in an alternative embodiment of the present invention, the media production application 11a also includes its own web browser functionality for interfacing to the merchant's computer.

The operation of the present invention will now be described with reference to the flow diagrams of FIGS. 5 and 6.

In this embodiment of the present invention, customers connect to the merchant's computer 1 using their web browser (step S1) to access a web page. Using known techniques it can be determined whether the customer is an existing known customer (step S2). This can be checked, for example, by checking a cookie loaded on the customer's computer 1 or 2, or this can simply be manually determined by asking for the customer to select whether they are an existing customer. If they are an existing customer, they will automatically proceed to the vending process.

If they are not an existing customer, the merchant's computer will send a request for customer information to the customer's computer (step S3). This will take the form of a web page requesting information to be entered by the customer. The customer will enter the information in the web page and this will be sent to the merchant's computer (step S4). The merchant's computer can also obtain information on the configuration of the customer's computer and this is received at the merchant's computer (step S5). The information is validated (step S6) and this can take the form of simple validation to check whether the form of the data is valid, or more complex validation against known data. If the information is determined not to be valid (step S7) the merchant's computer sends an invalid information notice to the customer's computer (step S8) and this can be in the form of a web page. The process then returns to step S3 whereby the merchant's computer sends a request for customer information to the customer's computer, i.e. a web page is displayed requesting valid information.

If the information is determined to be valid, the information is stored in the merchant's computer, i.e. in the customers information 50 (step S9) and the process proceeds to the vending process.

Thus at the end of the process of FIG. 5, customer information is obtained to populate the customer information part 50 of the database 5. Referring now to FIG. 6, during the vending process, the merchant's computer initializes a check on the customer's computer configuration (step S10) to determine the hardware and software configuration. This is checked against information stored in the customers information 50. If it is determined that the configuration of the customer's computer has changed (step S11) the merchant's computer updates the stored configuration information stored in the customer information 50. If the configuration of the customer's computer is not changed (step S11) and if it has changed and the updated configuration information has been stored, the merchants computer then initializes a check on the media production application stored in the customer's computer (step S13). Thus, information is determined on the version of the media production application stored on the customer's computer and this is compared with information stored in the downloaded client software region 56 of the database 5 to determine whether it is the latest version (step S14). If it is not the latest version, the merchant's computer looks up the latest version for the customer's computer configuration (step S15) and downloads the latest version to the customer's computer where it is installed (step S16). A customer customized user interface is then generated by the merchant's computer and displayed on the customer's computer (step S17), i.e. a customized web page for the customer. The web page can be customized as is well known in the art, based on the customer information to show information relevant to the customer and to personalize the interface. For example, the interface can be customized based on the customer's previous purchases to show electronic media products which the customer may be interested in purchasing. The system then awaits a customer selection of the demonstration of an electronic media product (step S18) and/or the selection by a customer to buy an electronic media product (step S20). If a customer selects to obtain a demonstration of the electronic media product (step S18) a demonstration electronic media product is downloaded to the customer's computer and played (step S19). If the electronic media product is a CD, a sample of the tracks or a single track can be played at the customer's computer as a demonstration of the product. If the product is a DVD, a sample video clip can be downloaded and played. If the product is a computer program, a limited version of the program, or a demonstration of the program in the form of a video can be downloaded and played or executed.

When a customer selects to buy the electronic media product (step S20) the merchant's computer accesses the electronic media files and associated electronic media packaging files and downloads them to the customer's computer. Files are thus temporarily stored in the file memory 12 or 12a (step S21). The media production application then uses the electronic media files stored in the file memory 12 or 12a in order to produce the electronic media product (step S22). The process then returns to step S17 to allow a customer to choose to download further electronic media products.

The production of the electronic media product can either be carried out automatically as soon as the electronic media data and the associated electronic media packaging data are stored in the file memory 12. The media production application 11 can immediately read the data and control the writing of the electronic media data and the printing of the electronic media packaging data to produce the electronic media product. Alternatively, the actual production of the electronic media product can be delayed until a user has selected to produce the product. Thus, in this embodiment the media production application 11 generates an interface to identify the electronic media products available to be produced based on the data stored in the file memory 12. This embodiment is particularly useful for enabling multiple downloads of data for electronic media products. For example, a batch download of data for a plurality of electronic media products can be carried out overnight and the products can be produced one-by-one by the customer by selecting to do so. This process is particularly advantageous where the customer's computer is only provided with writing devices capable of writing to one electronic media product at a time and requires physical intervention in order to change the blank electronic media ready for the production of the next electronic media product. With a customer's computer having such a limitation, the batch processing of electronic media products is not possible. Thus, the user selection or intervention between downloading of the files and generation of the electronic media product overcomes this limitation in the customer's equipment.

In the flow diagram of FIG. 6, no description is given of personalization of the electronic media product. It is possible, in one embodiment of the present invention, to allow the customer to select to personalize the electronic media product to be purchased.

This can be achieved, for example, by allowing a customer to select the order of tracks in a CD. It can also be achieved by allowing a customer to select the style and type of packaging or to personalize the packaging by adding personal information such as a customer's name to the packaging. It is thus possible, for example, for a user to personalize a CD by selecting their own order of tracks for the CD, selecting the type of sleeve for the CD and adding their name to the sleeve of the CD.

In this embodiment of the present invention, the files that are downloaded from the merchant's computer can be encrypted and can be combined together in the form of a single set of data which is only readable by the media production application. This provides some security against multiple production of electronic media products from the data stored in the file memory 12 or 12a. However, as a further security measure against multiple production of electronic media products, the media production application 11 or 11a can delete the data stored in the file memory 12 or 12a once the electronic media product has been produced.

In the present invention, the electronic media production can be made as a result of payment for the electronic media product, or without payment simply by request for the electronic media product. Where a charge is made for the electronic media product, upon selection of the electronic media product to be downloaded, a conventional payment request such as a shopping cart model can be used in order to enable a customer to enter their payment details. Alternatively, payment information can be stored in the customer information 50 in the database 5 and whenever a customer selects to download an electronic media product, payment can be automatically deducted from a customer's account or using their credit information stored in the customer information 50.

The packaging information which is printed can include instructions for the customer of how to put the electronic media product together, i.e. how to fold the packaging or where to place the packaging in a case, e.g. a jewel case for a CD and how to fix the label printed for the electronic media, e.g. how to fix the CD label to the CD media.

For security, downloaded electronic media data and electronic media packaging data can be watermarked or marked with individual serial numbers. This provides the ability to trace copies of the data when illegal copies are found. Also the downloaded files can be in encrypted form and are hence decrypted upon receipt.

In one embodiment of the present invention the customer information 50 stores a record of previous transactions, i.e. previous electronic media products downloaded. The customer information 50 will also keep a record of the customer's computer configuration. Thus, if for a previous download the customer's computer configuration did not enable, for example, colour printing, i.e. the customer only had a black and white printer, when it is detected that the customer upgrades their computer configuration, e.g. the customer upgrades to a colour printer, the next time that the customer connects to the merchant's computer, the customer's computer will be provided with an upgraded media production application. The merchant's computer can then allow the customer's computer to print a colour version of the packaging for previously downloaded electronic media products. Thus this provides a bonus for continued use of the service in order to obtain an upgraded product when the computer's configuration is upgraded.

The website hosted by the merchant's computer 4 also provides links to associated merchandise for electronic media products as identified in the merchandise information 54 in the database 5. Further, access to web cam sites associated with downloadable electronic media products is available from the merchant's computer based on the information in the web cam information 55 in the database 5.

Although the present invention been described hereinabove with reference to specific embodiments, it will be apparent to a skilled person in the art that variations lie within the spirit and scope of the present invention.

For example, although the embodiments have been described with reference to computers being used by customers, the present invention encompasses the use of any apparatus suitable for production of the electronic media products.

Although the embodiments of the present invention illustrate the printing of the packaging on a paper type of medium, the present invention encompasses printing directly on the electronic medium as part of the packaging, e.g. printing directly on a CD rather than printing on a label and applying it to a CD.

The present invention thus provides a personal media factory enabling customers to produce their own physical electronic media products based only on data downloaded over a communications network. The production of the electronic media is automated, such as by an application, so that there is no intervention required by the customer to write the data to an electronic media and to print the packaging. A user can delay the automatic generation of the product to await their positive selection of the generation of the product but no other intervention is required.

Although in one embodiment of the present invention the system is based around the vending of the electronic media products, the present invention is not limited to the exchange of payment in return for the electronic media product, the electronic media production system in accordance with the present invention need not require payment and the product can simply be provided on a request.

1. An electronic media production apparatus for producing at least one electronic media product, each electronic media product comprising electronic media and packaging for the electronic media, the apparatus comprising:
receiving means for receiving electronic media data and associated electronic media packaging data from a data source over a communications system;
media writing control means responsive to received electronic media data to control media writing means to write the received electronic media data to at least one electronic media; and
printing control means responsive to received electronic media packaging data to control printing means to print electronic media packaging for said at least one electronic media using the received electronic media packaging data.

2. An electronic media production apparatus according to claim 1, wherein said media writing control means is adapted to control the media writing means to automatically write the received electronic media data to at least one electronic media and said printing control means is adapted to control the printing means to automatically print the electronic media packaging for said at least one electronic media using the received electronic media packaging data.

3. An electronic media production apparatus according to claim 1, including means for generating a user interface to identify at least one electronic media product for which electronic media data and associated electronic media packaging data for the electronic media has been received and to allow a user to input a user selection of one or more of said at least one identified electronic media products, and said media writing control means is adapted to control the media writing means to write the received electronic media data to at least one electronic media in dependence upon the input user selection and said printing control means is adapted to control the printing means to automatically print the electronic media packaging for said at least one electronic media using the received electronic media packaging data in dependence upon the input user selection.

4. An electronic media production apparatus according to claim 1, wherein said media writing means includes an electronic media writing application, and said media writing control means is adapted to control said media writing application by passing said received electronic media data to said media writing application for writing to said at least one electronic media.

5. An electronic media production apparatus according to claim 1, wherein said printing means includes a printing application, and said printing control means is adapted to control said printing means by passing said received electronic media packaging data to said printing application for printing said received electronic media packaging data.

6. An electronic media production apparatus according to claim 1, including means for generating a user interface to allow a user to input a user selection of at least one electronic product to be produced, and means for transmitting said input user selection to the data source over said communication system to cause the data source to transmit corresponding electronic media data and electronic media packaging data for receipt by said receiving means.

7. An electronic media production apparatus according to claim 6, including means for generating a payment interface to allow a user to enter payment information for said at least one electronic product to be produced.

8. An electronic media production apparatus according to claim 6, including means for receiving demonstration electronic media data from said data source, and means for playing or executing the electronic media data to play or execute a demonstration of the electronic media product.

9. A carrier medium carrying computer readable code for controlling a computer to produce at least one electronic media product, each electronic media product comprising electronic media and packaging for the electronic media, the code comprising code for controlling the computer to:
receive electronic media data and associated electronic media packaging data from a data source over a communications system;
control a media writing system in response to received electronic media data to write the received electronic media data to at least one electronic media; and
control a printing system in response to received electronic media packaging data to print electronic media packaging for said at least one electronic media using the received electronic media packaging data.

10. A carrier medium according to claim 9, wherein the code for controlling the media writing system is arranged to control the media writing system to automatically write the received electronic media data to at least one electronic media and the code for controlling the printing system is arranged to control the printing system to automatically print the electronic media packaging for said at least one electronic media using the received electronic media packaging data.

11. A carrier medium according to claim 9, wherein said code comprises code for controlling the computer to generate a user interface to identify at least one electronic media product for which electronic media data and associated electronic media packaging data for the electronic media has been received to allow a user to input a user selection of one or more of said at least one identified electronic media products, and said code for controlling the media writing system is arranged to control the media writing system to write the received electronic media data to at least one electronic media in dependence upon the input user selection and the code for controlling the printing system is arranged to control the printing system to automatically print the electronic media packaging for said at least one electronic media using the received electronic media packaging data in dependence upon the input user selection.

12. A carrier medium according to claim 9, said media writing system includes an electronic media writing application, and the code for controlling the media writing system is adapted to control said media writing application by passing said received electronic media data to said media writing application for writing to said at least one electronic media.

13. A carrier medium according to claim 9, wherein said printing system includes a printing application, and the code for controlling the printing system is arranged to control said printing system by passing said received electronic media packaging data to said printing application for printing said received electronic media packaging data.

14. A carrier medium according to claim 9, wherein said code includes code for generating a user interface to allow a user to input a user selection of at least one electronic product to be produced, and code for transmitting said input user selection to the data source over said communication system to cause the data source to transmit corresponding electronic media data and electronic media packaging data for receipt by said receiving means.

15. A carrier medium according to claim 9, wherein said code includes code for generating a payment interface to allow a user to enter payment information for said at least one electronic product to be produced.

16. A carrier medium according to claim 14, wherein said code includes code for receiving demonstration electronic media data from said data source, and code for playing or executing the electronic media data to play or execute a demonstration of the electronic media product.

17. An electronic media production system for enabling a remote apparatus to produce at least one electronic media product, each electronic media product comprising electronic media and packaging for the electronic media, the system comprising:
a code store comprising the carrier medium according to claim 9;
a data source comprising electronic media data and associated electronic media packaging data for a plurality of electronic media products; and
a communications interface for connection to a communications system for
and the code in said code store to the remote apparatus.

18. An electronic media production system according to claim 17, wherein said communications interface is adapted to receive a user selection identifying an electronic media product to be produced, and to retrieve and download electronic media data and associated electronic media packaging data corresponding to the user selection.

19. An electronic media production system according to claim 17, including payment means for receiving payment information from the remote apparatus for the selected electronic media product to be produced.

20. An electronic media production system according to claim 17, wherein said code store stores a plurality of versions of the code for different configurations of remote apparatuses, the system including a configuration information store storing configuration information for the remote apparatus, and code determining means for determining the version of the code to be downloaded based on the stored configuration information.

21. An electronic media production system according to claim 20, wherein said code determining means is adapted to determine a code version, if any, at said remote apparatus, to compare the determined version with at least one version in said code store, and to determine whether to download code and if so what version to download based on the result of the comparison.

22. An electronic media production system according to claim 20, including configuration information determining means for determining information on the configuration of the remote apparatus for storage in said configuration information store.

23. An electronic media production system according to claim 17, including personalisation means for allowing personalisation of the content of said electronic media data and/or said electronic media packaging data before downloading by said communications interface.

24. An electronic media production system according to claim 23, wherein said personalisation means includes a personalisation interface to allow a user of said remote apparatus to enter personalisation data or selections for use in personalising said electronic media data and/or said electronic media packaging data.

25. An electronic media production system for enabling a remote apparatus to produce at least one electronic media product, each electronic media product comprising electronic media and packaging for the electronic media, the system comprising a code store comprising the carrier medium according to claim 9.

26. An electronic media production system for enabling a remote apparatus to produce at least one electronic media product, each electronic media product comprising electronic media and packaging for the electronic media, the system comprising:
a data source comprising electronic media data and associated electronic media packaging data for a plurality of electronic media products;
a communications interface for connection to a communications system for downloading said electronic media data and associated electronic media packaging data to the remote apparatus; and
personalisation means for allowing personalisation of the content of said electronic media data and/or said electronic media packaging data before downloading by said communications interface.

27. An electronic media production system according to claim 26, wherein said personalisation means includes a personalisation interface to allow a user of said remote apparatus to enter personalisation data or selections for use in personalising said electronic media data and/or said electronic media packaging data.

28. A method of selling electronic media products, the electronic media products comprising electronic media and packaging for the electronic media, the method comprising:
storing electronic media data and associated electronic media packaging data for a plurality of electronic media products;
receiving a purchase request for at least one electronic media product from a remote user over a communications network; and
downloading electronic media data and associated electronic media packaging data for said at least one electronic media product to an application executed at said remote user for the production of said at least one electronic media product by said application by writing said electronic media data to at least one electronic media and sending said electronic media packaging data to a printer to print packaging for the electronic media.

29. A method of purchasing electronic media products, the electronic media products comprising electronic media and packaging for the electronic media, the method comprising:
sending a purchase request to a source of electronic media over a communications network;
receiving electronic media data and associated electronic media packaging data for said at least one electronic media from said source of electronic media in response to the request;
writing said electronic media data to at least one electronic media; and
sending said electronic media packaging data to a printer to print packaging for the electronic media.
